(19) United States
(12) Patent Application Publication
(10) Pub. No.: US 2016/0141775 A1
(43) Pub. Date: May 19, 2016

(54) PLUG ASSEMBLY

(71) Applicant: ZF Friedrichshafen AG, Friedrichshafen (DE)

(72) Inventors: Josef LOIBL, Bad Abbach (DE); Christoph SCHIKORA, Regensburg (DE)

(21) Appl. No.: 14/940,316

(22) Filed: Nov. 13, 2015

(30) Foreign Application Priority Data
Nov. 19, 2014 (DE) 102014223644.4

(51) Int. Cl. H01R 12/57; H01R 13/52

(52) U.S. Cl. CPC H01R 12/57; H01R 13/5219

(57) ABSTRACT

A plug assembly having at least one plug element comprising a plug base body having numerous plug pins, wherein the side of the plug base body facing away from the plug pins is oriented toward a sealing space. The plug pins face a surrounding space. The side of the plug base body oriented toward the sealing space is coated such that it is sealed off to media.

### PRIORITY STATEMENT

This application claims the benefit of German Patent Application DE 10 2014 223 644.4, filed Nov. 19, 2014, and incorporates the German Patent Application by reference herein in its entirety.

### FIELD

The present invention relates to a plug assembly having at least one plug element.

### BACKGROUND

Plug assemblies of this type are used to provide electrical connections to structural elements or suchlike. The plug elements of the plug assembly are also used in sealing spaces that are exposed to media. For this reason, plug elements are needed that are sealed accordingly, and that ensure that no media can get into the environment from the sealed space, or vice versa. In order to ensure that the plug is sealed, plug elements having a so-called base socketing are used, in which the plug element is entirely coated, and the base of the plug is sealed with a casting compound. It is also conceivable that the plug pins have a special contour and are press-fitted into thermoplastic. The contour of the plug pins in combination with the press-fitting ensures a seal. The aforementioned solutions, however, have proven to be complicated in terms of production, and cost-intensive. Moreover, the structural composition of the plug element is complicated.

### SUMMARY

A plug assembly having at least one plug element is proposed, comprising a base body having numerous plug pins, wherein the side of the plug base body facing away from the plug pins faces a sealing space and the plug pins face a surrounding space. According to the embodiment, it is provided that only the side of the plug base body facing the sealing space is coated such that it is sealed off to media. As a result, not only the production costs are reduced, the construction of the plug assembly is also clearly simplified.

The separating plane is advantageously placed between the sealing space, or the medium, respectively, a seal and the surrounding space, such that an assembly is obtained that is sealed off to media, without the need for a complicated base socketing on the plug element. Furthermore, press-in pins or suchlike are not needed, such that the plug assembly according to the invention can be used universally.

The proposed plug assembly can preferably be used in gearbox casings, wherein the plug assembly is provided, for example, as a part of the gearbox control for transmitting electric signals for controlling the gearbox in the gearbox housing. Furthermore, the solution also automatically offers protection against contamination of the pins, preventing possible short circuits between the pins. Other applications are also conceivable. It should be understood that the description and specific examples are intended for purposes of illustration only and are not intended to limit the scope of the present disclosure.

### BRIEF DESCRIPTION OF THE DRAWINGS

FIG. 1 shows a schematic view of a first design variation of a plug assembly according to the present disclosure;

FIG. 2 shows a schematic view of a second design variation of the plug assembly;

FIG. 3 shows a schematic view of a third design variation of the plug assembly; and

FIG. 4 shows a schematic view of a fourth design variation of the plug assembly.

### DETAILED DESCRIPTION OF EXAMPLE EMBODIMENTS

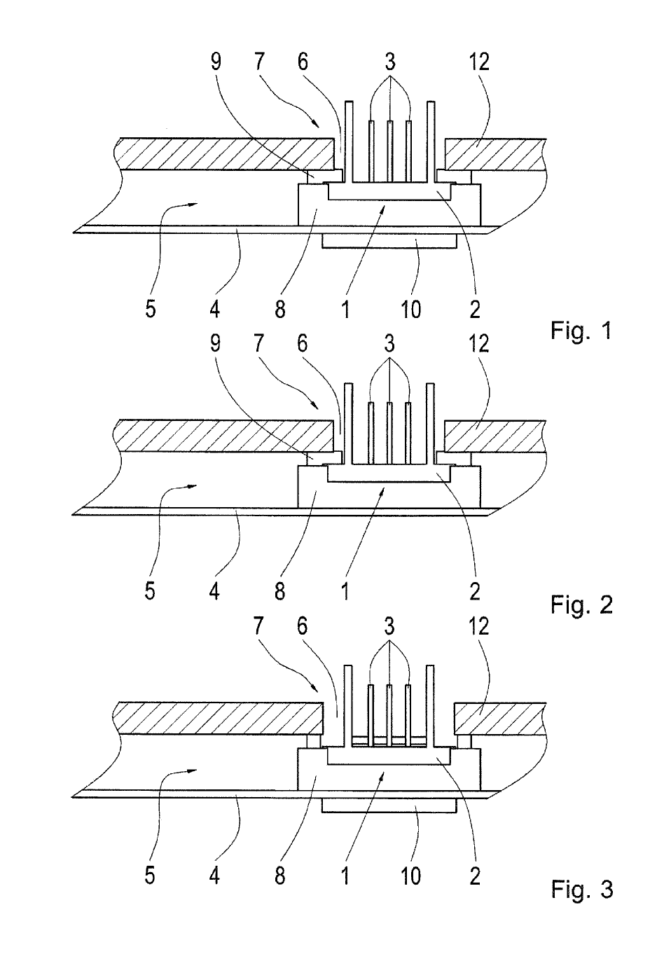

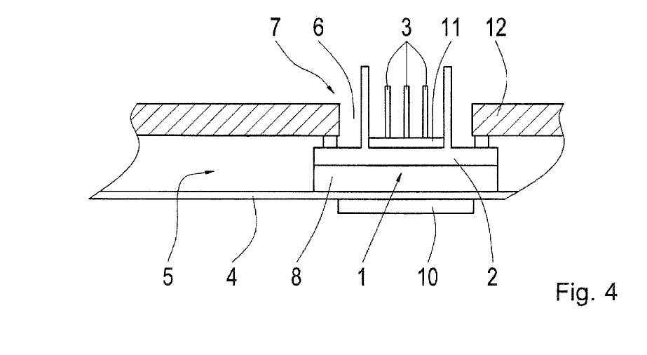

Four different design variations of a plug assembly according to the present disclosure are depicted in an exemplary manner in FIGS. 1 to 4, with a gearbox casing 12, which is merely indicated. FIGS. 3 and 4 depict only the single function of protection against contamination for all possible plugs.

For all the design variations, the plug assembly comprises at least one plug element 1, comprising a plug base body 2 having numerous plug pins 3. The plug base body 2 is made from inexpensive thermoplastic, for example, wherein the plug pins 3 are attached to the plug base body 2. The plug base body 2 is electrically connected, at the side of the plug element facing away from the plug pins, to a printed circuit board 4, by means of brazing or press-fit, for example. The side of the plug base body 2 connected to the printed circuit board 4 faces a sealing space 5, e.g. a gearbox casing or suchlike. A sealing space wall opening 6 of the sealing space 5 is allocated to the side of the plug base body 2 provided with the plug pins 3, such that the plug pins 3 pass through the wall opening 6 to the exterior into a surrounding space 7. In this manner, the plug pins 3 can be connected to electronic components in the exterior surrounding space 7, such as the gearbox control or suchlike, for example.

According to the present disclosure, it is provided that the side of the plug base body 2 facing the sealing space 5, on which the printed circuit board 4 is attached, is coated such that it is sealed off to media. Thus, in any case, the connecting region between the printed circuit board 4 and the plug base body 2 is coated in a manner sealed off to media. In this manner, the part of the plug base body 2 facing the sealing space 5 is hermetically sealed due to the coating 8, which may comprise thermosetting plastics, for example. As a result, it is ensured that media cannot get into the environment, or the surrounding space 7, respectively, from the sealing space 5 through the plug base body. Conversely, the passage of media or contaminants from the environment into the sealing space 5 is likewise prevented. The sealing of the separating plane between the plug base body 2 and the coating 8 is obtained by means of the axial seal 9, which is always present, and which seals the axial gap in the region of the sealing space wall opening 6 in a media-tight manner, as is depicted in FIG. 1.

A design variation is shown in FIG. 2, in which the brazing is omitted on the lower guard 10.

Further design variations are depicted in FIGS. 3 and 4, in which a plug is integrated with a base socketing 11, and the coating 8 serves as a contamination protection, or as a mechanical attachment to the printed circuit board or lead frame, respectively.

### REFERENCE NUMERALS

1 plug element

2 plug base body

3 plug pin

4 printed circuit board

5 sealing space

6 sealing space wall opening

7 surrounding space

8 coating

9 axial seal

10 guard

11 base socketing

12 gearbox casing

What is claimed is:

1. A plug assembly having at least one plug element comprising:
a plug base body comprising a plurality of plug pins, wherein a side of the plug base body facing away from the plurality of plug pins is oriented toward a sealing space, wherein the plurality of plug pins are oriented toward a surrounding space, wherein at least a portion of the side of the plug base body oriented toward the sealing space is coated such that it is sealed off to media.

2. The plug assembly according to claim 1, wherein the sealing space is defined by a wall and wherein the plug element is disposed such that the plurality of plug pins are in an opening in the wall, and wherein the side of the plug base body oriented toward the sealing space is electrically connected to a printed circuit board.

3. The plug assembly according to claim 2, wherein at least a connecting region between the printed circuit board and the plug base body is coated such that it is sealed off to media.

4. The plug assembly according to claim 1, wherein the plug base body is made from a thermoplastic.

5. The plug assembly according to claim 1, wherein thermosetting plastic is provided as the coating for the plug base body.

6. The plug assembly according to claim 1, wherein the plug element is disposed as a part of a gearbox control in the sealing space, wherein the sealing space is within a gearbox casing.

7. The plug assembly according to claim 2, wherein brazing connects the printed circuit board to the plug base body oriented toward the sealing space.

8. The plug assembly according to claim 2, wherein a press-fit bond connects the printed circuit board to the plug base body oriented toward the sealing space.

9. The plug assembly according to claim 2, wherein the plurality of plug pins are configured to be connected to an electronic component located outside of the sealing space.

10. The plug assembly according to claim 9, wherein the plurality of plug pins are connected to a gearbox control.

11. The plug assembly according to claim 1, wherein the at least a portion of the side of the plug base body oriented toward the sealing space is hermetically sealed by the coating.

12. The plug assembly according to claim 2, wherein the coating of the at least a portion of the side of the plug base body oriented toward the sealing space prevents media from leaving the sealing space through the opening in the wall and prevents media from entering the sealing space through the opening in the wall.

13. The plug assembly according to claim 1, further comprising an axial seal between the sealing space and the surrounding space.

14. The plug assembly according to claim 13, wherein the sealing space is defined by a wall and wherein the axial seal is located between the wall and the coating for the plug base body.

15. The plug assembly according to claim 14, wherein the plug element is disposed such that the plurality of plug pins are in an opening in the wall and wherein the axial seal extends into the opening.

16. The plug assembly according to claim 1, wherein the side of the plug base body oriented toward the sealing space is electrically connected to a printed circuit board, the plug assembly further comprising a guard located on a side of the printed circuit board opposite the connection with the plug base body.

17. The plug assembly according to claim 1, further comprising a base socket located at the intersection of the plug base body and the plurality of plug pins.

18. The plug assembly according to claim 1, wherein the coating for the plug base body attaches the plug base body to a printed circuit board.

19. A gearbox casing comprising:
a casing wall that defines a sealing space within the gearbox casing;
a plug element with a plug base body, wherein the plug base body includes a plurality of plug pins, wherein a side of the plug base body facing away from the plurality of plug pins is oriented toward the sealing space, wherein at least a portion of the side of the plug base body oriented toward the sealing space is coated such that it is sealed off to media from outside the casing wall.

20. The gearbox casing according to claim 19, wherein the plurality of plug pins are configured to connect to a gearbox control to transmit electrical signals for controlling a gearbox in the gearbox casing.
